(19) United States
(12) Patent Application Publication
(10) Pub. No.: US 2021/0187767 A1
(43) Pub. Date: Jun. 24, 2021

(54) Use Tracking Razor Assembly

(71) Applicant: Michael Solomon, Philadelphia, PA (US)

(72) Inventor: Michael Solomon, Philadelphia, PA (US)

(21) Appl. No.: 16/719,303

(22) Filed: Dec. 18, 2019

(51) Int. Cl. B26B 21/40

(52) U.S. Cl. CPC B26B 21/4087

(57) ABSTRACT

A use tracking razor assembly for tracking the number of times a razor has been used for shaving includes a razor handle that has an engagement thereon for releasably engaging a razor head for shaving. A dial is rotatably coupled to the engagement and the dial can be rotated by a user. The dial is sequentially rotated between a start position and an end position each time the razor head is employed for shaving. In this way the dial assists the user with keeping track of the number of times the razor head has been used.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to use tracking devices and more particularly pertains to a new use tracking device for tracking the number of times a razor has been used for shaving.

### (2) Description of Related Art Including Information Disclosed Under 37 CFR 1.97 and 1.98

The prior art relates to use tracking devices. The prior art discloses a razor handle that has a slidable indicator for tracking the number of times the razor has been used. The prior art discloses a wear strip that reveals indicia when a razor has been used a sufficient number of times. Additionally, the prior art discloses a potentiometer that is in mechanical communication with razor blades in a razor for determining how hard a user is pressing on the razor to shave, thereby determining the wear of the razor blade. The prior art discloses a toothbrush handle that has a counter integrated therein, which can be depressed by a user, for tracking the number of times the toothbrush has been employed.

### BRIEF SUMMARY OF THE INVENTION

An embodiment of the disclosure meets the needs presented above by generally comprising a razor handle that has an engagement thereon for releasably engaging a razor head for shaving. A dial is rotatably coupled to the engagement and the dial can be rotated by a user. The dial is sequentially rotated between a start position and an end position each time the razor head is employed for shaving. In this way the dial assists the user with keeping track of the number of times the razor head has been used.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a use tracking razor assembly according to an embodiment of the disclosure.

FIG. 2 is a top view of an embodiment of the disclosure.

FIG. 3 is a left side phantom view of an embodiment of the disclosure.

### DETAILED DESCRIPTION OF THE INVENTION

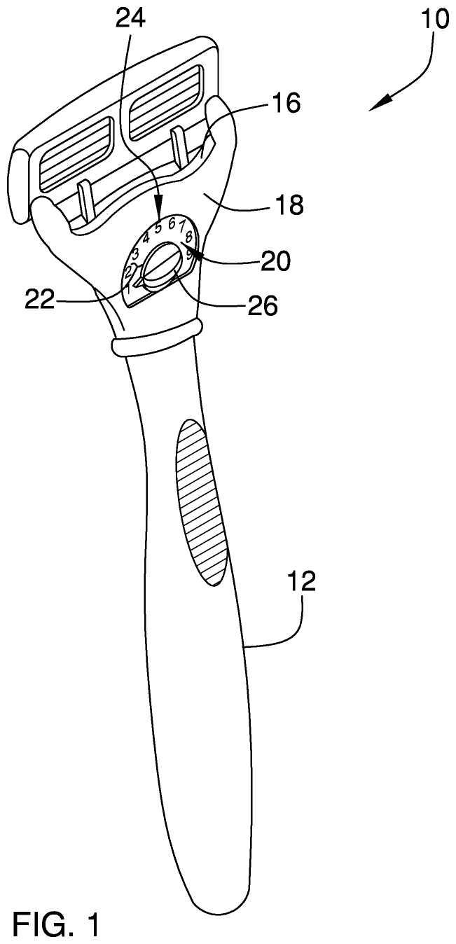

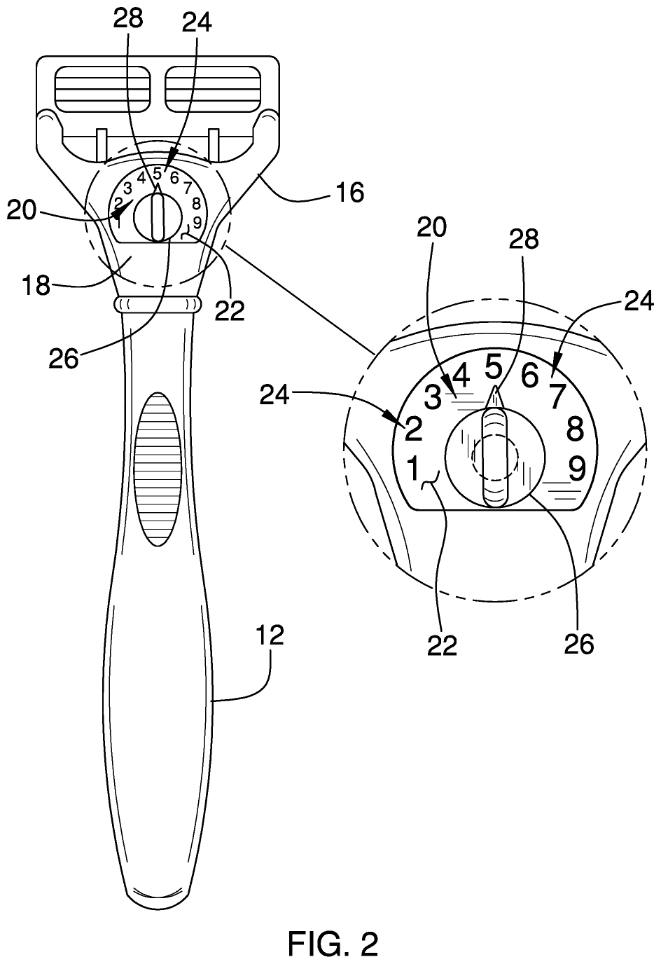

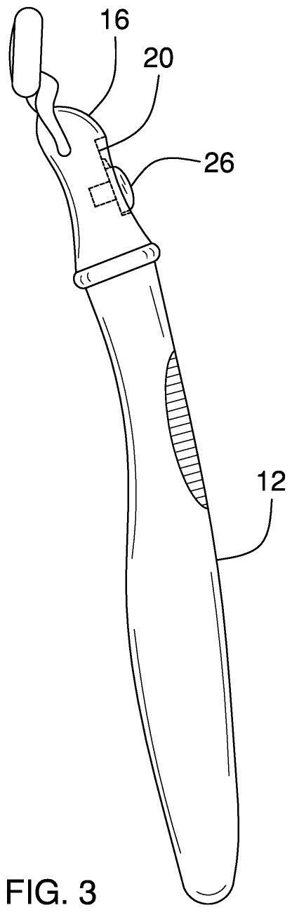

With reference now to the drawings, and in particular to FIGS. 1 through 3 thereof, a new use tracking device embodying the principles and concepts of an embodiment of the disclosure and generally designated by the reference numeral 10 will be described.

As best illustrated in FIGS. 1 through 3, the use tracking razor assembly 10 generally comprises a razor handle 12 has an engagement 14 thereon for releasably engaging a razor head 16 for shaving. The razor head 16 may be a disposable razor head of any conventional design. Additionally, the razor handle 12 may be a disposable razor handle of any conventional design. The engagement 14 has a top side 18 and the top side 18 has a recess 20 therein. The recess 20 has a lower bounding surface 22 and the lower bounding surface 22 has indicia 24 printed thereon. The indicia 24 comprise numbers from “1” through “9” and the indicia 24 are distributed along an arc along a perimeter of the recess 20.

A dial 26 is rotatably coupled to the engagement 14 and the dial 26 can be rotated by a user. The dial 26 is sequentially rotated between a start position and an end position each time the razor head 16 is employed for shaving. In this way the dial 26 assists the user with keeping track of the number of times the razor head 16 has been used. The dial 26 is positioned on the lower bounding surface 22 of the recess 20 and the dial 26 has a pointer 28 extending away from the dial 26. Moreover, the pointer 28 is directed toward each of the numbers as the dial 26 is rotated. The pointer 28 is directed toward the number “1” when the dial 26 is in the start position and the pointer 28 is directed toward the number “9” when the dial 26 is in the end position.

In use, the dial 26 is rotated to point at the number “1” when the razor head 16 is first attached to the razor handle 12. The dial 26 is rotated one position each time the razor head 16 is used for shaving. In this way the user can track the number of times the razor head 16 has been used. Thus, the user can more accurately determine when it is time to replace the razor head 16. The dial 26 is rotated to point at the number “1” each time the razor head 16 is replaced to start the process over again.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A use tracking razor assembly being configured to track the number of times a razor has been used for shaving, said assembly comprising:
a razor handle having an engagement thereon for releasably engaging a razor head for shaving, said engagement has a top side, said top side having a recess therein, said recess having a lower bounding surface fully surrounded by a peripheral wall; and
a dial being rotatably coupled to said engagement and positioned fully inset into said recess wherein said dial is configured to be rotated by a user, said dial being sequentially rotated between a start position and an end position each time said razor head is employed for shaving wherein said dial is configured to assist the user with keeping track of the number of times said razor head has been used.

2. The assembly according to claim 1, wherein said lower bounding surface having indicia being printed thereon, said indicia comprising numbers from 1 through 9, said indicia being distributed along an arc along a perimeter of said recess.

3. A use tracking razor assembly being configured to track the number of times a razor has been used for shaving, said assembly comprising:
a razor handle having an engagement thereon for releasably engaging a razor head for shaving, said engagement having a top side, said top side having a recess therein, said recess having a lower bounding surface fully surrounded by a peripheral wall, said lower bounding surface having indicia being printed thereon, said indicia comprising numbers from 1 through 9, said indicia being distributed along an arc along a perimeter of said recess; and
a dial being rotatably coupled to said engagement and positioned fully inset into said recess wherein said dial is configured to be rotated by a user, said dial being sequentially rotated between a start position and an end position each time said razor head is employed for shaving wherein said dial is configured to assist the user with keeping track of the number of times said razor head has been used.

4. (canceled)

5. A use tracking razor assembly being configured to track the number of times a razor has been used for shaving, said assembly comprising:
a razor handle having an engagement thereon for releasably engaging a razor head for shaving, said engagement having a top side, said top side having a recess therein, said recess having a lower bounding surface fully surrounded by a peripheral wall, said lower bounding surface having indicia being printed thereon, said indicia comprising numbers from 1 through 9, said indicia being distributed along an arc along a perimeter of said recess; and
a dial being rotatably coupled to said engagement and positioned fully inset into said recess wherein said dial is configured to be rotated by a user, said dial being sequentially rotated between a start position and an end position each time said razor head is employed for shaving wherein said dial is configured to assist the user with keeping track of the number of times said razor head has been used, said dial being positioned on said lower bounding surface of said recess, said dial having a pointer extending away from said dial, said pointer being directed toward each of said numbers as said dial is rotated, said pointer being directed toward said 1 when said dial is in said start position, said pointer being directed toward said 9 when said dial is in said end position.
